(19) United States
(12) Patent Application Publication
(10) Pub. No.: US 2016/0135188 A1
(43) Pub. Date: May 12, 2016

(54) METHODS AND APPARATUS FOR COMMUNICATING EXTENDED FREQUENCY CHANNEL NUMBERS

(71) Applicant: QUALCOMM Incorporated, San Diego, CA (US)

(72) Inventor: Mungal Singh Dhanda, Slough (GB)

(21) Appl. No.: 14/932,558

(22) Filed: Nov. 4, 2015

Related U.S. Application Data
(60) Provisional application No. 62/076,380, filed on Nov. 6, 2014.

(51) Int. Cl. H04W 72/04

(52) U.S. Cl. CPC H04W 72/0453; H04W 72/042

(57) ABSTRACT

Various aspects provide for determining whether an Evolved Universal Terrestrial Radio Access (E-UTRA) Absolute Radio Frequency Channel Number (EARFCN) value is greater than a predetermined reserved value for at least one neighbouring cell. If the EARFCN value is greater than the predetermined reserved value, various aspects further provide for including the predetermined reserved value in an E-UTRA Network (E-UTRAN) neighbour cell structure and providing one or more extended EARFCNs used in the E-UTRAN in an extended EARFCN structure included in an existing system information message used in a Global System for Mobile Communications (GSM) random access network (RAN). The predetermined reserved value may be equal to 0xFFFF. The existing system information message may be a SYSTEM INFORMATION TYPE 2quater message according to a GSM Enhanced Data rates for GSM Evolution (EDGE) RAN (GERAN) standard.

### PRIORITY CLAIM

This application claims priority to and benefit of provisional patent application No. 62/076,380 filed in the United States Patent and Trademark Office on Nov. 6, 2014, the entire content of which is hereby incorporated herein by reference.

### TECHNICAL FIELD

Aspects of the present disclosure relate, generally, to wireless communication and, more particularly, to communicating extended frequency channel numbers.

### BACKGROUND

Various radio access network (RAN) technologies are widely deployed to provide many types of wireless communication content such as voice, video, packet data, messaging, broadcast, and so on. Some radio access network (RAN) technologies, such as Global System for Mobile Communications (GSM) Enhanced Data rates for GSM Evolution (EDGE) Radio Access Network (GERAN), broadcast messages that have been designed to support and carry Long Term Evolution (LTE) Evolved Universal Terrestrial Radio Access (E-UTRA) Absolute Radio Frequency Channel Numbers (EARFCNs), which designate carrier frequencies for uplink and downlink communication.

Some systems may utilize EARFCNs ranging from 0 through 65535, and 16-bit values may sufficiently cover this range. However, due to increased demand for wireless communication, the number of supported frequency bands and associated subcarrier frequencies has increased. Accordingly, an extension of the EARFCN range may be appropriate for designating such frequencies. In some circumstances, the range of EARFCNs has been increased fourfold from 65536 values (i.e., values 0 through 65535) to 262,144 values (i.e., values 0 through 262,143), for which 18-bit values may be appropriate to designate such a range extension. Accordingly, wireless communication systems may benefit from techniques that utilize extended EARFCNs to accommodate such a range extension.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the present disclosure provides a method of wireless communication. The method may include determining whether an Evolved Universal Terrestrial Radio Access (E-UTRA) Absolute Radio Frequency Channel Number (EARFCN) value is greater than a predetermined reserved value for at least one neighbouring cell. If the EARFCN value is greater than the predetermined reserved value, the method may also feature including this EARFCN value in a new extended EARFCN structure and replacing this EARFCN value with a predetermined reserved value in an E-UTRA Network (E-UTRAN) neighbour cell structure in an existing system information message used in a Global System for Mobile Communications (GSM) random access network (RAN). The method may also feature including the extended EARFCN structure in the existing system information message. The method may also include communicating the existing system information message to at least one mobile station operable in the GSM RAN.

In another aspect, the present disclosure provides an apparatus for wireless communication. The apparatus includes a communications interface, a storage medium, and at least one processor communicatively coupled to the communications interface and the storage medium. The at least one processor and the storage medium may be configured to determine whether an EARFCN value is greater than a predetermined reserved value for at least one neighbouring cell. If the EARFCN value is greater than the predetermined reserved value, the at least one processor and the storage medium may be further configured to include the predetermined reserved value in an E-UTRAN neighbour cell structure and provide one or more extended EARFCNs used in the E-UTRAN in an extended EARFCN structure included in an existing system information message used in a GSM RAN. The at least one processor and the storage medium may be further configured to communicate the existing system information message to at least one mobile station operable in the GSM RAN.

In yet another aspect, the present disclosure provides a computer-readable medium that includes computer-executable instructions. The computer-executable instructions may be configured to determine whether an EARFCN value is greater than a predetermined reserved value for at least one neighbouring cell. If the EARFCN value is greater than the predetermined reserved value, the computer-executable instructions may be further configured to include the predetermined reserved value in an E-UTRAN neighbour cell structure and provide one or more extended EARFCNs used in the E-UTRAN in an extended EARFCN structure included in an existing system information message used in a GSM RAN. The computer-executable instructions may be further configured to communicate the existing system information message to at least one mobile station operable in the GSM RAN.

In a further aspect, the present disclosure provides another method of wireless communication. The method may include determining whether an EARFCN value in an E-UTRAN neighbour cell structure is equal to a predetermined reserved value. If the EARFCN value in the E-UTRAN neighbor cell structure is equal to the predetermined reserved value, the method may include reconstructing an E-UTRAN neighbor cell list by replacing the predetermined reserved value with an extended EARFCN value included in an extended EARFCN structure contained in an existing system information message if the extended EARFCN structure contains at least one EARFCN value. Once an EARFCN value from an extended EARFCN structure is used to replace a reserved value in an E-UTRAN neighbor cell list, then this EARFCN value is deleted from the extended EARFCN structure. The extended EARFCN value may be greater than the predetermined reserved value. If the EARFCN value is not equal to the predetermined reserved value, the method may include decoding the E-UTRAN neighbour cell structure without using the extended EARFCN value included in the existing system information message.

These and other aspects of the present disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating an example of a network according to aspects of the present disclosure.

FIG. 2 is a diagram illustrating an example of a network architecture according to aspects of the present disclosure.

FIG. 3 is a diagram illustrating an example of various methods and/or processes performed according to aspects of the present disclosure.

FIG. 4 is a diagram illustrating an example of a hardware implementation of an apparatus according to aspects of the present disclosure.

FIG. 5 is a diagram illustrating an example of a hardware implementation of another apparatus according to aspects of the present disclosure.

FIG. 6 is a diagram illustrating another example of various methods and/or processes performed according to aspects of the present disclosure.

FIG. 7 is a diagram illustrating yet another example of various methods and/or processes performed according to aspects of the present disclosure.

### DESCRIPTION OF SOME EXAMPLES

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Some solutions for supporting Evolved Universal Terrestrial Radio Access (E-UTRA) Absolute Radio Frequency Channel Numbers (EARFCNs) for Global System for Mobile Communications (GSM) Enhanced Data rates for GSM Evolution (EDGE) Radio Access Network (GERAN) have been suggested to the Technical Specification Group of the 3rd Generation Partnership Project (3GPP) GERAN working group (e.g., GP-140631 and GP-140625 proposed to 3GPP GERAN WG2 for 3GPP TS 44.018). One of these solutions proposes re-use of 16-bit unused EARFCNs over the GERAN radio interface. However, this solution has certain limitations. Firstly, this solution does not provide a four-times increase in the EARFCN value range. Secondly, this solution requires mapping in the network, thereby increasing complexity. Another proposed solution involves adding extended EARFCN values defined by 18 bits in a system information (SI) message, as previously introduced into the GERAN standard for GERAN network sharing and denoted as a SYSTEM INFORMATION TYPE 23 message. If devices do not support GERAN full network sharing, however, those devices will not support this SI message. This may be problematic due to increased implementation and testing/verification costs and increased power consumption. For example, a mobile station would still have to read the SYSTEM INFORMATION TYPE 23 message in order to construct an E-UTRAN neighbor cell list, as well as other existing SI messages, such as the SYSTEM INFORMATION Type 2quater message, which is described in greater detail herein.

Various aspects of the present disclosure provide methods and apparatus that effectuate transmission of extended Long Term Evolution (LTE)/E-UTRAN EARFCN values larger than 65535, particularly for GERAN, while mitigating increased implementation and verification costs and power consumption. In some aspects, such methods and apparatus provide for adding the extended EARFCN values in an extant SI message that has already been introduced for GERAN network sharing with non-GERAN network sharing mobile devices, rather than using a new SI message introduced to the GERAN specification for transmitting these values. In an example, those LTE EARFCN values larger than 65535 may be added to an existing SI message (e.g., a SYSTEM INFORMATION TYPE 2quater message, which may be abbreviated as “SI2q message”) such that the remaining parameters for the cells on this EARFCN can be carried by the existing fields in the existing message. Because a mobile station will still have to read an extant SI message, such as the SI2q message, due to its inclusion of significant and particular information only broadcast therein (e.g., GERAN-related information, CSG cell information, etc.), power savings can be realized by utilizing the message for multiple purposes, including transmission of extended EARFCN values.

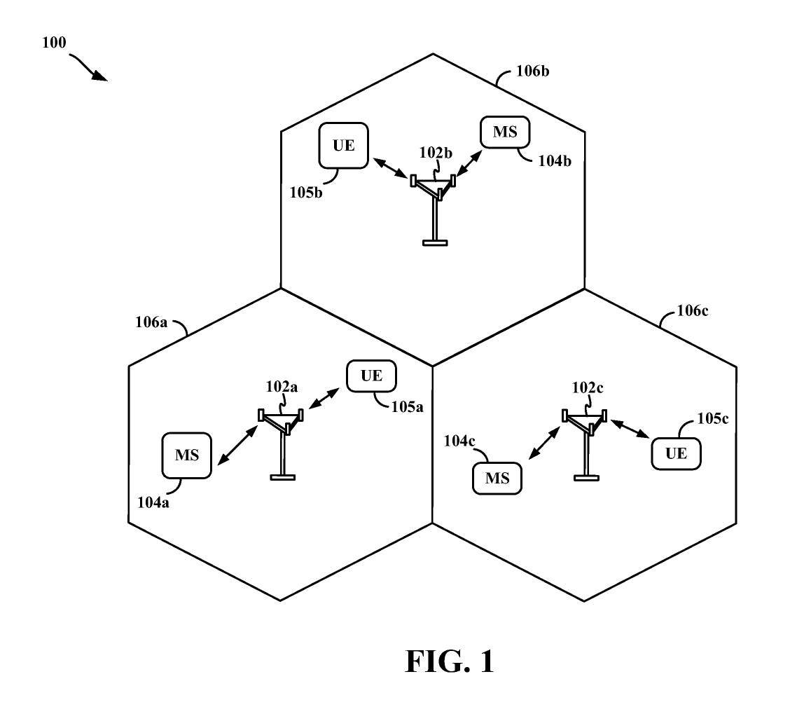

For the purpose of contextualization, FIG. 1 illustrates an example of a network 100 in which the presently disclosed methods and apparatus may be implemented. The network 100 may be a multi-cell as well as multi-RAN environment where multiple RAN technologies may be present and one or more User Equipments (UEs) 104a, 104b, 104c and/or one or more Mobile Stations (MSs) 105a, 105b, 105c may have mobility across the various RANs. In one example, the RAN technologies may be E-UTRAN and GERAN.

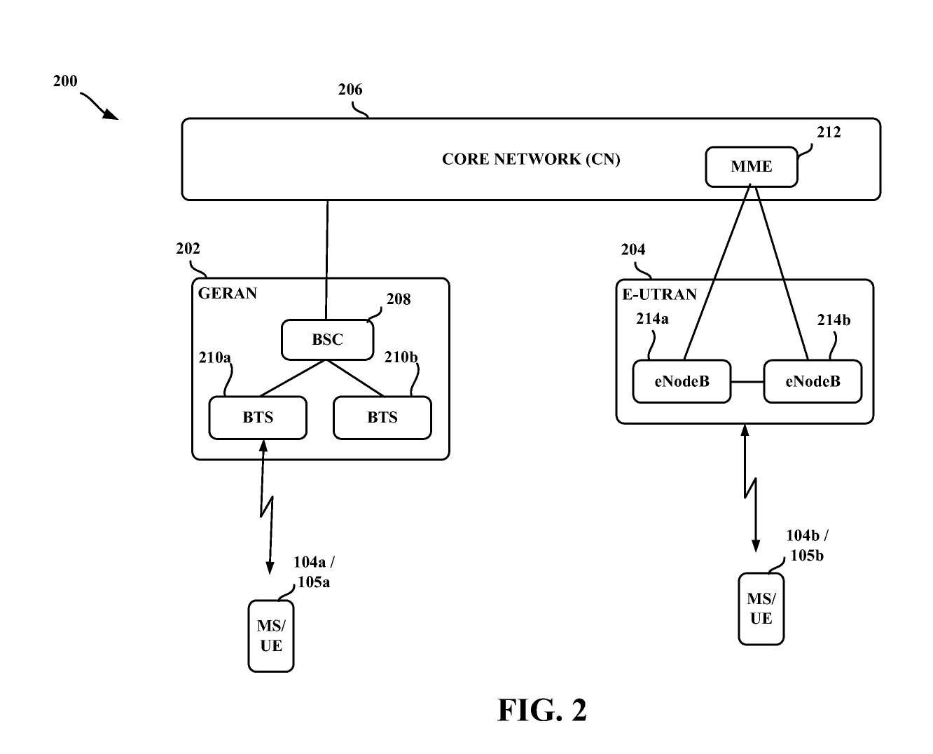

Base station 102a, 102b, 102c may also be referred to as and/or may include some or all of the functionality of a device called a NodeB, an evolved NodeB (eNodeB or eNB), an access point (AP), a base transceiver station (BTS), a broadcast transmitter, and various other suitable terms. Each base station 102a, 102b, 102c provides communication coverage for a particular geographic area. A base station 102a, 102b, 102c may provide communication coverage for one or more wireless communication devices. The term “cell” can refer to a base station 102a, 102b, 102c and/or its coverage area depending on the context in which the term is used. The base stations 102a, 102b, 102c can wirelessly communicate with the MSs 104a, 104b, 104c and/or UEs 105a, 105b, 105c via a base station antenna. The base stations 102a, 102b, 102c may each be implemented generally as a device adapted to facilitate wireless connectivity (e.g., for one or more of the MSs 104a, 104b, 104c and/or UEs 105a, 105b, 105c) to the network 100. The base stations 102a, 102b, 102c are configured to communicate with the MSs 104a, 104b, 104c and/or UEs 105a, 105b, 105c under the control of base station control (see FIG. 2) via multiple carriers. Each base station 102a, 102b, 102c can provide radio access communication coverage for a respective geographic area. The respective coverage areas for the base stations 102a, 102b, 102c are identified as cells 106a, 106b, and 106c. The coverage area for a base station 102a, 102b, 102c may be divided into sectors (not shown), which make up only a portion of the coverage area. The network 100 may include base stations 102a, 102b, 102c of different types (e.g., macro base stations, micro base stations, femto base stations, and/or pico base stations) without deviating from the scope of the present disclosure.

One or more of the MSs 104a, 104b, 104c and/or UEs 105a, 105b, 105c may be extant within the cells 106a, 106b, 106c. Each of the MSs 104a, 104b, 104c and/or UEs 105a, 105b, 105c may communicate with one or more base stations 102a, 102b, 102c. An MS 104a, 104b, 104c and/or a UE 105a, 105b, 105c may generally refer to a device that communicates with one or more other devices through wireless signals. One of ordinary skill in the art will understand that the MSs 104a, 104b, 104c and/or UEs 105a, 105b, 105c referenced herein may additionally or alternatively be referred to using various other nomenclatures, such access terminals, subscriber stations, mobile units, subscriber units, wireless units, remote unit, mobile device, wireless device, wireless communications devices, remote devices, mobile subscriber stations, mobile terminals, wireless terminals, remote terminals, handsets, terminals, mobile clients, clients, mobile phones, smart phones, wireless modems, personal media players, laptop computers, tablet computers, network enabled televisions, appliances, e-readers, digital video recorders (DVRs), machine-to-machine (M2M) devices, and/or various other communication/computing devices which communicate, at least partially, via a radio access network.

The network 100 may include a multiple-access system capable of supporting communication with multiple wireless communication devices (e.g., MSs 104a, 104b, 104c and/or UEs 105a, 105b, 105c) by sharing the available system resources (e.g., bandwidth and/or transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) GERAN, LTE systems, and spatial division multiple access (SDMA) systems.

FIG. 2 illustrates a block diagram of a network architecture 200 particular to a mixed RAN environment utilizing GSM (e.g., GERAN 202) and LTE (e.g., E-UTRAN 204) radio access networks. As illustrated, the network architecture 200 may include a base station subsystem (BSS) that implements a GERAN 202 and an E-UTRAN 204. The radio access networks are generally adapted to manage traffic and signaling between one or more access terminals (e.g., MS(s) 104a, 104b and/or UE(s) 105b, 105b) and one or more other network entities, such as via a core network (CN) 206. The RANs (e.g., GERAN 202, E-UTRAN 204) may be tied to the CN 206 providing various services to the access terminals (e.g., MS(s) 104a, 104b and/or UE(s) 105b, 105b) that are connected via the RANs (e.g., GERAN 202, E-UTRAN 204). The CN 206 may include a circuit-switched (CS) domain and a packet-switched (PS) domain. In general, an access terminal (e.g., MS(s) 104a, 104b and/or UE(s) 105b, 105b) can obtain access to a public switched telephone network (PSTN) (not shown) via the CS domain and to an IP network (not shown) via the PS domain.

Included within the GERAN 202 may be various numbers of base station controllers (BSCs), shown in FIG. 2 with only one exemplary BSC 208 for simplicity. Each BSC 208 may control one or more base transceiver stations (BTSs) 210a, 210b. Each of the BTSs 210a, 210b communicates with various access terminals (e.g., MS(s) 104a, 104b and/or UE(s) 105b, 105b) via radio uplink and downlink. The BSC 208 may also be referred to by those of skill in the art as a radio network controller (RNC). The BSC 208 is generally responsible for the establishment, release, and maintenance of wireless connections within one or more coverage areas associated with the one or more base stations 102a, 102b, 102c which are connected to the BSC 208. The BSC 208 may be communicatively coupled to one or more nodes or entities of the CN 206.

The E-UTRAN 204 includes a number of eNodeBs 214a, 214b. In evolved networks, the eNodeBs 214a, 214b may be connected with one or more Mobility Management Entities (MMES) 212, along with various gateways used for evolved systems (not shown). An MME 212 may handle, among other things, signalling related to mobility and security for access to the E-UTRAN 204. Each of the eNodeBs 214a, 214b communicates with various access terminals (e.g., MS(s) 104a, 104b and/or UE(s) 105b, 105b) via the radio uplink and downlink. The eNodeBs 214a, 214b may communicate with each other via an X2 interface.

According to one aspect, the present disclosure provides for construction of or updating of a neighbor cell list to assist with GERAN-LTE mobility that supports extended LTE EARFCN values. In one example, a BSS may be adapted to provide the extended LTE EARFCN in an extended EARFCN structure contained in an already existing SI message (e.g., the SI2q message under the GERAN specification). In such case, the present methodology may provide that the EARFCN found within the BSS internal neighbour cell structure (e.g., the E-UTRAN neighbor cells) is replaced with a reserved EARFCN value normally set at 0xFFFF. The value 0xFFFF may be a value predetermined as having no use in the current GERAN standard and may not be allocated in LTE for imparting a frequency channel number. In some examples, the value 0xFFFF is a reserved value. This value may be used as a signal or pointer that directs an access terminal (e.g., MS 104a, 104b and/or UE 105b, 105b) receiving the information that an extended EARFCN value is further included. An example of the process for constructing and transmitting a neighbour cell list in a BSS for GERAN 202 is depicted below in Table 1 below.

As may be seen in Table 1 below, when a BSS constructs a neighbor list to broadcast to the access terminals (e.g., MS(s) 104a, 104b and/or UE(s) 105b, 105b), the BSS neighbour cell structure for neighbouring cells that may have an EARFCN value less than the 16 bit value 0xFFFF (i.e., the hexadecimal number for 65535 in decimal form) will be directly mapped to a value the same as the transmitted neighbour cell structure (i.e., a non-extended EARFCN value using 16 bits). For example, Cell Index 0 has an EARFCN value less than 0xFFFF capable of being denoted with a 16 bit value, thus the BSS neighbour structure containing value EARFCN 1 and other parameters will be the same as the transmitted neighbour cell structure having EARFCN 1 and the parameters. On the other hand, if the EARFCN value for a neighbouring cell is greater than 0xFFFF in the BSS's neighbour cell structure (e.g., EARFCN 2 for Cell Index 1 in Table 1 below) requiring more than a 16-bit designator, then the transmitted neighbour cell structure will be mapped to a value 0xFFFF as an indicator or pointer and to other parameters. The value 0xFFFF then acts as a pointer to or indicator of the further included extended EARFCN list also placed within the SI2q message having the extended EARFCN value greater than 16 bits (e.g., EARFCN 2 in Table 2 below). It is noted that as 0xFFFF was a dedicated value used in the LTE standards, and the use of this value is not appropriating a value that was used previously.

TABLE 1
Process for constructing extended EARFCN list in the BSS

| Cell | BSS internal | Transmitted | Extended |
|---|---|---|---|
| Index | Neighbour cell struct | Neighbour cell struct | EARFCN list |
| 0 | EARFCN 1 | EARFCN 1 | |
| | (<0xFFFF) | | |
| | Other Parameters | Other Parameters | |
| 1 | EARFCN 2 | 0xFFFF | EARFCN 2 |
| | (>0xFFFF) | | |
| | Other Parameters | Other Parameters | |
| 2 | EARFCN 3 | 0xFFFF | EARFCN 3 |
| | (>0xFFFF) | | |
| | Other Parameters | Other Parameters | |
| 3 | EARFCN 4 | EARFCN 4 | |
| | (<0xFFFF) | | |
| | Other Parameters | Other Parameters | |

As noted above, the value 0xFFFF may not be utilized for designating EARFCNs in GERAN systems. Thus, the present disclosure further provides that an extended EARFCN list is utilized to transmit the larger EARFCN 2 value, typically using 18 bits, although the field is not necessarily limited to such, and could be set to values commensurate with even larger EARFCNs that require designations beyond 18-bit values. In one aspect, this extended EARFCN list is transmitted in an existing SI message, such as the SYSTEM INFORMATION 2quater message. Although the example of Table 1 illustrates four (4) cells, either more or less neighboring cells are also contemplated. Additionally, although the example illustrates two cells having EARFCNs represented by 16-bit values (e.g., Cell Indices 0 and 3) and two cells having EARFCNs only denoted by more than 16 bits (e.g., Cell Indices 1 and 2), many variations are contemplated according to the particular neighboring cell EARFCNs of a particular BSS.

From a coding aspect, the extended EARFCN structure may be coded as follows:

< Repeated Extended EARFCN struct > ::=
{ 1 < EARFCN : bit (18) > } ** 0

The extended EARFCN may also be required for E-UTRAN closed subscriber group (CSG) cells having limited sets of users and dedicated frequencies under present 3GPP standards. Accordingly, in a further aspect, the extended EARFCN is also used for E-UTRAN CSGs. This can be done, according to a particular aspect, by adding a release 12 extension structure, which may be coded as follows:

< E-UTRAN CSG Extended EARFCN struct > ::=
{ 1 < CSG_EARFCN : bit (18) > } ** 0 ;-- E-UTRAN CSG Dedicated
Frequencies

In terms of increased overhead cost imposed upon the SI2q message, it is noted that each extended EARFCN may consume (17+19)*n+1 bits (assuming an 18-bit extended EARFCN), where n refers to the number of extended EARFCNs. This message extension calculation includes both the usage of reserved EARFCN values within E-UTRAN neighbour cells structure and the size of the extended EARFCN. The remaining E-UTRAN neighbour cell parameters may not take up extra added space, assuming that these parameters are the same as for 16-bit EARFCN frequencies. Thus, for example, if one (1) extended EARFCN is added to the SI2q message, the resultant space extension will amount to 37 extra bits, assuming that the E-UTRAN neighbour cell parameters use the same space as 16-bit-denoted EARFCN frequencies.

Table 2 below illustrates examples of space extensions in the SI2q message corresponding to various numbers of extended EARFCN cells added to the message.

TABLE 2
SI2q message space extension

| | | | | |
|---|---|---|---|---|
| No. of Extended | 1 | 2 | 3 | 4 |
| EARFCN Cells | | | | |
| Message extension | 37 | 73 | 109 | 145 |
| (bits) | | | | |

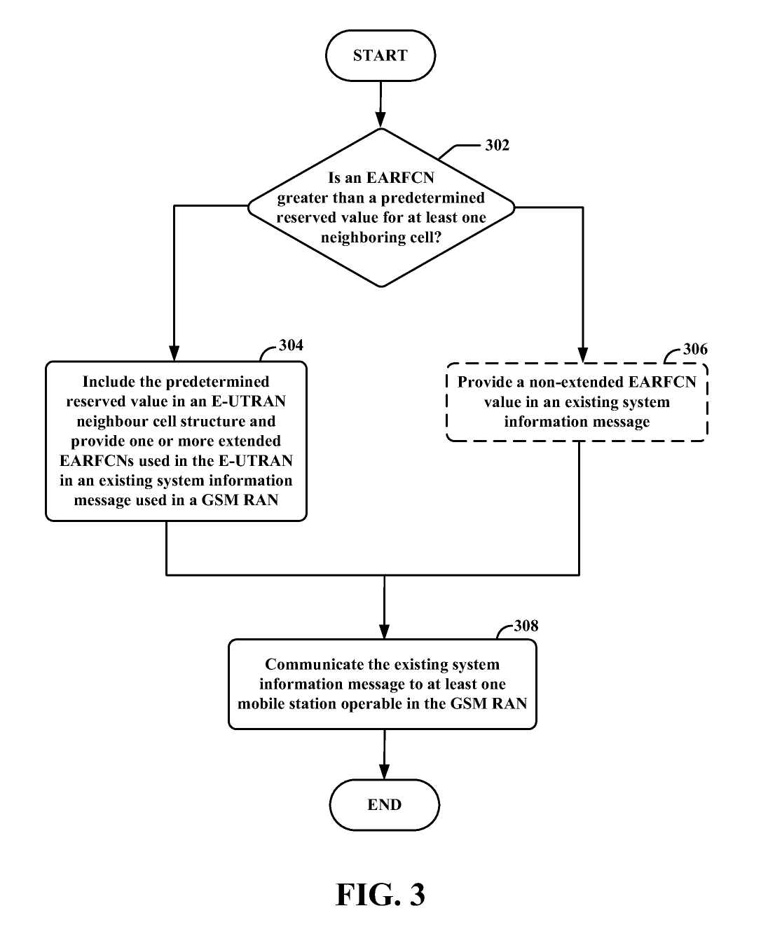

FIG. 3 illustrates a flow diagram of an exemplary method for communicating extended EARFCN values to mobile stations for, among other things, constructing a neighbour list in accordance with the methodology discussed above. At block 302, the method includes determining whether an EARFCN value is greater than a predetermined reserved value for at least one neighbouring cell. As described in greater detail above, the predetermined reserved value may have a value equal to 0xFFFF. The value 0xFFFF may be the hexadecimal number for 65535 in decimal form. The value 0xFFFF may be a value predetermined as having no use in the current GERAN standard. This value may be used as a signal or pointer that directs an access terminal (e.g., MS 104a, 104b and/or UE 105b, 105b) receiving the information that an extended EARFCN value is further included.

If the EARFCN is greater than the predetermined value, at block 304, the method may also feature including (e.g., replacing, inserting, appending, etc.) the predetermined reserved value in an E-UTRAN neighbour cell structure and providing one or more extended EARFCNs used in the E-UTRAN in an extended EARFCN structure contained in an existing system information message used in a GSM RAN. Various examples are provided above with reference to Tables 1 and 2. In some examples, if the EARFCN value for a neighbouring cell is greater than 0xFFFF in the BSS's neighbour cell structure (e.g., EARFCN 2 for Cell Index 1 in Table 1 above) and requiring more than a 16-bit designator, then the transmitted neighbour cell structure may be mapped to a value 0xFFFF as an indicator or pointer and to other parameters. The value 0xFFFF functions as a pointer to or indicator of the further included extended EARFCN list also placed within the SI2q message having the extended EARFCN value greater than 16 bits (e.g., as shown in Table 2 above).

On the other hand, if the EARFCN is not greater than the predetermined value, at block 306, the method may include providing a non-extended EARFCN value in an existing system information message. Various examples are provided above with reference to Table 1. For instance, Cell Index 0 has an EARFCN value less than 0xFFFF capable of being denoted with a 16 bit value. Accordingly, the BSS neighbour structure containing value EARFCN 1 will be the same as the transmitted neighbour cell structure having EARFCN 1 (as shown in Table 1 above).

At block 308, the method includes communicating the existing system information message to at least one mobile station operable in the GSM RAN. As described in greater detail above, the GSM RAN may be a GERAN. In some examples, the existing system information message is a SI2q message according to a GERAN standard. In some examples, the one or more extended EARFCNs are provided in the SI2q message to at least one non-GERAN network sharing mobile station.

One of ordinary skill in the art will understand that the foregoing method(s) may be implemented by various apparatuses without deviating from the scope of the present disclosure. In some examples, these methods may be implemented by processes performed by a BSS in a GERAN. The BSS may be operable to provide the extended EARFCNs in the existing SI2q message as a modification thereof. In some aspects, this modified construction of the SI2q message may be implemented within one or more BTSs (e.g., BTS 210a, 210b), a BSC (e.g., BSC 208), and/or any other component of a BSS (e.g., a BSS for GERAN 202).

It is contemplated that other existing SI messages of different types in the GERAN standard potentially could be utilized instead of the SI2q message, should the 3GPP GERAN TSG make changes to the GERAN specifications in a manner that another existing SI message (or other existing fields) would be more optimal for minimizing power consumption. That is, regardless of the likelihood that the standard would be changed in such manner, it is contemplated that the underlying methodology herein of choosing an existing message to communicate EARFCNs rather than adding new SI messages to the GERAN specification that achieves the advantage of less change to the number or structure of overhead messaging could still be considered for minimizing the modification of network elements and better optimization of power consumption.

As described in greater detail above, the SI message may be communicated by transmission to at least one mobile station operable in the RAN in order to communicate, among other things, the EARFCNs (including extended EARFCNs). In some examples, the method(s) of FIG. 3 may further include providing the extended EARFCNs in an extended EARFCN structure with the existing system information message, wherein the EARFCNs within the E-UTRAN neighbour cell structure may be replaced with a predetermined reserved value (e.g., 0xFFFF) in the existing SI message. This process is utilized for those EARFCN values greater than 16 bits, for example, as discussed above in connection with Table 1. In some examples, the method(s) of FIG. 3 may include determining whether the EARFCN value is less than the predetermined reserved value (e.g., 0xFFFF) for at least one neighboring cell. If so, then a non-extended EARFCN value is provided in the existing SI message when the EARFCN value is less than the predetermined EARFCN value (0xFFFF).

As described above, the communicated existing SI message is configured to allow the at least one mobile station operable in the RAN to construct a neighbor list including one or more neighboring cells operable according to an LTE standard, the process of which will be described in more detail below. According to still a further aspect, the method of FIG. 3 may expressly account for a CSG cell configured under the E-UTRAN standard. The method include determining the presence of CSG cells and provide an extended EARFCN in the existing SI message (e.g., the SI2q message) for the determined or known E-UTRAN CSG cells.

In a further aspect, the process of FIG. 3 may be configured to only extend EARFCN values within the SYSTEM INFORMATION TYPE 2quater message for non-GERAN network sharing mobiles, while those mechanisms provided in previous standards proposals (e.g., GP-140631 proposed to 3GPP GERAN WG2 for 3GPP TS 44.018) can be used for GERAN-sharing modes. Thus, in one aspect, the method of FIG. 3 may include a process of first determining whether an access terminal is a sharing or non-GERAN network sharing access terminal, and decide whether to include the EARFCN values in the SI2q message for only those non GERAN network sharing mobiles. Accordingly, the one or more extended EARFCNs may be provided in the existing SI message to the at least one mobile station when it is determined to be a non-GERAN network sharing access terminal It is noted, however, that it is not necessary for the network to determine that there is at least one access terminal that is a non-GERAN network sharing access terminal Thus, in another aspect, the broadcast information may be configured to cater to both types of access terminal without necessarily knowing their network-sharing capability, wherein the SI message is be configured such that both types, including non-GERAN network sharing access terminals may be capable of receiving and processing the message such that extended EARFCNs will be communicated to the non-GERAN network sharing access terminals.

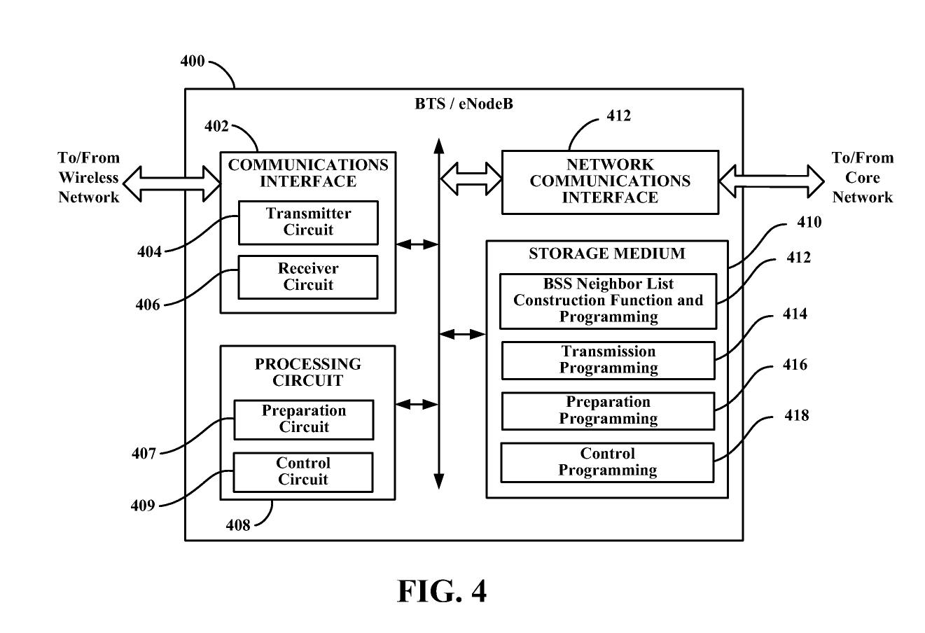

FIG. 4 is a block diagram illustrating select components of an exemplary apparatus 400, which may be the same as a base station, BTS, and/or eNodeB described above. The apparatus 400 may be operable for communicating extended EARFCN values according to the method discussed above in connection with FIG. 3 and Table 1. One skilled in the art will appreciate that the functional components shown in FIG. 4 and their associated functions may also be effected by other devices within a BSS (e.g., the BSS of GERAN 202 in FIG. 2) or shared between various components in such a BSS. As illustrated, FIG. 4 shows that the apparatus 400 includes a communications interface 402 configured for radio link communication in a wireless network, such as radio communication with MSs/UEs (e.g., MSs 104a, 104b; UEs 105a, 105b). The communications interface 402 may include one or more transmitter circuits 404 and one or more receiver circuits 406. The communications interface 402 may be communicatively coupled with other components of the apparatus 400, including a processing circuit 408, a storage medium 410, and a network communications interface 412.

The communications interface 402 may be configured to facilitate wireless communications of the apparatus 400. For example, the communications interface 402 may include circuitry and/or programming adapted to facilitate the communication of information bi-directionally with respect to one or more network MSs (e.g., MSs 104a, 104b). The communications interface 402 may be communicatively coupled to one or more antennas (not shown). Additionally, the transmitter circuit 404 and the receiver circuit 406 may include, by way of example and not limitation, devices and/or programming associated with a data path (e.g., antenna, amplifiers, filters, mixers) and with a frequency path (e.g., a phase-locked loop (PLL) component).

The processing circuit 408 may be arranged to obtain, process and/or send data, control data access and storage, issue commands and messages, and control other desired operations. The processing circuit 408 may include circuitry adapted to implement desired programming provided by appropriate storage media in at least one example. For example, the processing circuit 408 may be implemented as one or more processors, one or more controllers, and/or other structure configured to execute executable programming. Examples of the processing circuit 408 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 408 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 408 are for illustration and other suitable configurations within the scope of the present disclosure are also contemplated.

The processing circuit 408 may be specifically configured to execute programming, which may be stored on the storage medium 410. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

As shown in FIG. 4, the storage medium 410 is illustrated with a BSS neighbor list construction function and programming 412. The BSS neighbor list construction function and programming 412 may be utilized, at least in part and in conjunction with other elements, to construct a neighbor list in the manner as discussed above in connection with Table 1. For example, the BSS neighbor list construction function and programming 412 may be configured to generate the SI messages for communicating the extended EARFCN values as well as to keep track or directly map the internal BSS internal neighbor cell structures to the communicated or transmitted neighbor cell structures, whether the EARFCN value or the predetermined 0xFFFF value, and to the extended EARFCN list when the EARFCN value is an extended value that may be represented using greater than 16 bits.

The storage medium 410 may include preparation programming 416. The preparation programming 416 may include computer-executable instructions configured to determine whether an EARFCN value is greater than a predetermined reserved value for at least one neighbouring cell. The storage medium 410 may also include control programming 418. The control programming 418 may include computer-executable instructions configured to include the predetermined reserved value in an E-UTRAN neighbour cell structure and provide one or more extended EARFCNs used in the E-UTRAN in an existing system information message used in a GSM RAN, if the EARFCN value is greater than the predetermined reserved value. The control programming 418 may also include computer-executable instructions configured to provide a non-extended EARFCN value in an existing system information message, if the EARFCN value is not greater than the predetermined reserved value. The storage medium 410 may also include transmission programming 414. The transmission programming 414 may include computer-executable instructions configured to communicate the existing system information message to at least one mobile station operable in the GSM RAN.

The storage medium 410 may represent one or more computer-readable, machine-readable, and/or processor-readable devices for storing programming, such as processor executable code or instructions (e.g., software, firmware), electronic data, databases, or other digital information. The storage medium 410 may also be used for storing data that is manipulated by the processing circuit 408 when executing programming The storage medium 410 may be any available media that can be accessed by a general purpose or special purpose processor, including portable or fixed storage devices, optical storage devices, and various other mediums capable of storing, containing and/or carrying programming By way of example and not limitation, the storage medium 410 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. The storage medium 410 may be communicatively coupled to the processing circuit 408 such that the processing circuit 408 can read information from, and write information to, the storage medium 410.

The network communications interface 412 shown in FIG. 4 may be configured to communicate with other network devices in the RAN, the BSS, the MME (in the case of eNodeB), and/or the CN. The network communications interface 412 may be configured to operate under any suitable communication protocol utilized in the various RAN standards.

The processing circuit 408 may include a preparation circuit 407. The preparation circuit 407 may include circuitry and other hardware components, which may perform various algorithms. Such circuitry, hardware components, and algorithms are some examples of structures corresponding to the means for determining whether an EARFCN value is greater than a predetermined reserved value for at least one neighbouring cell.

The processing circuit 408 may also a control circuit 409. The control circuit 409 may include circuitry and other hardware components, which may perform various algorithms. Such circuitry, hardware components, and/or algorithms are some examples of structures corresponding to the means for including the predetermined reserved value in an E-UTRAN neighbour cell structure and providing one or more extended EARFCNs used in the E-UTRAN in an existing system information message used in a GSM RAN, if the EARFCN value is greater than the predetermined reserved value. Such circuitry, hardware components, and/or algorithms are also some examples of structures corresponding to the means for providing a non-extended EARFCN value in an existing system information message, if the EARFCN value is not greater than the predetermined reserved value.

The transmitter circuit 404 of the communications interface 402 may include circuitry and other hardware components, which may perform various algorithms. Such circuitry, hardware components, and/or algorithms are some examples of structures corresponding to the means for means for communicating the existing system information message to at least one mobile station operable in the GSM RAN.

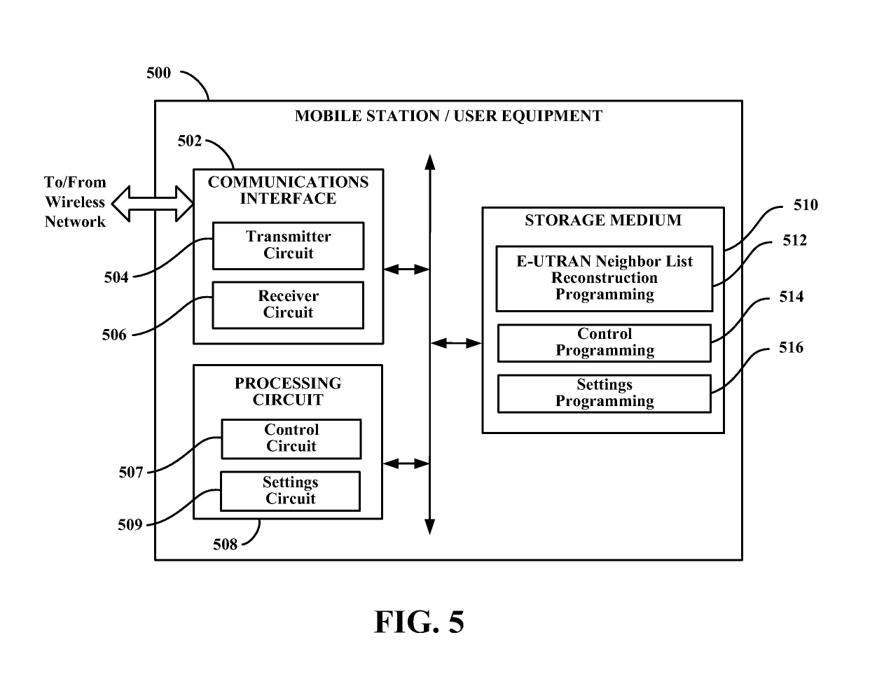

FIG. 5 is a block diagram illustrating another apparatus 500. The apparatus 500 may be an MS and/or a UE, as described in greater detail above. The apparatus 500 may be operable in multi-RAN environments, such as a GERAN/E-UTRAN environment. The apparatus 500 may include a communications interface 502 configured for wireless communication with one or more RANs. The communications interface 502 may include a transmit circuit 504 and a receiver circuit 506. For simplicity, the communications interface 502 is shown singular, but one skilled in the art will realize that the communications interface 502 may consist of multiple radio circuits, each configured to communicate with a respective RAN technology.

The apparatus 500 may also include a processing circuit 508 communicatively coupled with the communications interface 502 and a storage medium 510. The transmit circuit 504 and/or the receiver circuit 506 may be implemented as one or more processors, one or more controllers, and/or other structure configured to execute executable programming The storage medium 510 may be engendered as one or more computer-readable, machine-readable, and/or processor-readable devices for storing programming, such as processor executable code or instructions (e.g., software, firmware), electronic data, databases, or other digital information.

In connection with a particular aspect, the apparatus 500 and the processing circuit 508 may effectuate reconstruction of the E-UTRAN neighbour cell list based on the SI2q message transmitted by a BSS. Such functionality is shown symbolically as the E-UTRAN neighbour list reconstruction programming 512, as stored in the storage medium 510 and executable by the processing circuit 508.

In connection with the E-UTRAN neighbour list reconstruction programming 512, the neighbour cell structure is communicated to the apparatus 500 by the transmitted neighbour cell structure and the extended EARFCN list within the extended SI2q message constructed by the BSS. Such a process may involve first looking at the transmitted neighbour cell structure. If the EARFCN value for a particular cell index is less than the value 0xFFFF, it can be deduced that it is the actual EARFCN value, along with other parameters transmitted by the BSS. This reconstruction may be represented by the Cell Index 0 entry in Table 3 below, which is correlative to the construction shown earlier in Table 1, and wherein the internal neighbour cell structure (e.g., EARFCN 1) is the same as the received neighbour cell structure, along with other parameters.

TABLE 3
Process for reconstructing E-UTRAN Neighbor cells list in the MS

| | Transmitted | Extended | MS internal |
|---|---|---|---|
| Cell | Neighbour cell | EARFCN | Neighbour cell |
| Index | struct | list | struct |
| 0 | EARFCN 1 | | EARFCN 1 |
| | | | (<0xFFFF) |
| | Other Parameters | | Other Parameters |
| 1 | 0xFFFF | EARFCN 2 | EARFCN 2 |
| | | | (>0xFFFF) |
| | Other Parameters | | Other Parameters |
| 2 | 0xFFFF | EARFCN 3 | EARFCN 3 |
| | | | (>0xFFFF) |
| | Other Parameters | | Other Parameters |
| 3 | EARFCN 4 | | EARFCN 4 |
| | | | (<0xFFFF) |
| | Other Parameters | | Other Parameters |

If the EARFCN value for a particular cell index is the predetermined 0xFFFF value, it can be deduced that the EARFCN value is greater than 16 bits (e.g., greater than the 0xFFFF value) and is therefore contained as part of the extended EARFCN list. If the extended EARFCN list is empty then the EARFCN value set to 0xFFFF may be handled as an invalid value according to existing procedures. The extended list contains the extended EARFCN, along with other parameters transmitted by the BSS. This process of neighbour list reconstruction may be represented by the Cell Index 1 entry in Table 3 above, wherein the mobile station internal neighbour cell structure includes an extended EARFCN list value (e.g., EARFCN 2), along with other parameters.

The processing circuit 508 may be arranged to obtain, process and/or send data, control data access and storage, issue commands, and control other desired operations. The processing circuit 508 may be implemented as one or more processors, one or more controllers, and/or other structure configured to execute executable programming, including, but not limited to, a general purpose processor, a DSP, an ASIC, an FPGA, or any other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 508 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 508 are for illustration and other suitable configurations within the scope of the present disclosure are also contemplated.

The processing circuit 508 is adapted for processing, including the execution of programming, which may be stored on the storage medium 510. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The communications interface 502 may be configured to facilitate wireless communications of the apparatus 500. For example, the communications interface 502 may include circuitry and/or programming adapted to facilitate the communication of information bi-directionally with respect to one or more network nodes. The communications interface 502 may be coupled to one or more antennas (not shown), and includes wireless transceiver circuitry, including at least one receiver circuit 506 (e.g., one or more receiver chains) and/or at least one transmitter circuit 504 (e.g., one or more transmitter chains). By way of example and not limitation, the at least one receiver circuit 506 may include circuitry, devices and/or programming associated with a data path (e.g., antenna, amplifiers, filters, mixers) and with a frequency path (e.g., a PLL component).

As described in greater detail above, the storage medium 510 may include E-UTRAN neighbour list reconstruction programming 512. The E-UTRAN neighbour list reconstruction programming 512 may include computer-executable instructions configured to determine whether an EARFCN value in an E-UTRAN neighbour cell structure is equal to a predetermined reserved value. The E-UTRAN neighbour list reconstruction programming 512 may also include computer-executable instructions configured to reconstruct an E-UTRAN neighbor cell list by replacing the predetermined reserved value with an extended EARFCN value included in an existing system information message if the EARFCN value in the E-UTRAN neighbor cell structure is equal to the predetermined reserved value. The extended EARFCN value may be greater than the predetermined reserved value. The E-UTRAN neighbour list reconstruction programming 512 may also include computer-executable instructions configured to decode the E-UTRAN neighbour cell structure without using the extended EARFCN value included in the existing system information message if the EARFCN value is not equal to the predetermined reserved value.

The storage medium 510 may also include control programming 514. The control programming 514 may include computer-executable instructions configured to determine if a value in the system information message is equal to a predetermined EARFCN value for at least one cell identifier. The storage medium 510 may also include settings programming 516. The settings programming 516 may include computer-executable instructions configured to set an extended EARFCN value to a further extended EARFCN value contained in the system information message if the value is equal to the predetermined EARFCN value. The settings programming 516 may include computer-executable instructions configured to set the EARFCN value to the received value in the system information message if the value is less than the predetermined EARFCN value for the at least one cell identifier.

The storage medium 510 may represent one or more computer-readable, machine-readable, and/or processor-readable devices for storing programming, such as processor executable code or instructions (e.g., software, firmware), electronic data, databases, or other digital information. The storage medium 510 may also be used for storing data that is manipulated by the processing circuit 508 when executing programming The storage medium 510 may be any available medium that can be accessed by a general purpose or special purpose processor, including portable or fixed storage devices, optical storage devices, and various other mediums capable of storing, containing and/or carrying programming By way of example and not limitation, the storage medium 510 may include a computer-readable, machine-readable, and/or processor-readable storage medium such as a magnetic storage device (e.g., hard disk, floppy disk, magnetic strip), an optical storage medium (e.g., CD, DVD), a smart card, a flash memory device (e.g., card, stick, key drive), RAM, ROM, PROM, EPROM, electrically erasable EEPROM, a register, a removable disk, and/or other mediums for storing programming, as well as any combination thereof.

The storage medium 510 may be communicatively coupled to the processing circuit 508 such that the processing circuit 508 can read information from, and write information to, the storage medium 510. That is, the storage medium 510 can be coupled to the processing circuit 508 so that the storage medium 510 is at least accessible by the processing circuit 508, including examples where the storage medium 510 is integral to the processing circuit 508 and/or examples where the storage medium 510 is separate from the processing circuit 508 (e.g., resident in the apparatus 500, external to the apparatus 500, and/or distributed across multiple entities).

Programming stored by the storage medium 510, when executed by the processing circuit 508, causes the processing circuit 508 to perform one or more of the various functions and/or process steps described herein. For example, the storage medium 510 may include channel measurement and MCS determination operations. The channel measurement and MCS determination operations can be implemented by the processing circuit 508 and/or by a decoder circuit or processor in the communications interface 502. Thus, according to one or more aspects of the present disclosure, the processing circuit 508 is adapted to perform (in conjunction with the storage medium 510) any or all of the processes, functions, steps and/or routines for any or all of the access terminals described herein. As used herein, the term “adapted” in relation to the processing circuit 508 may refer to the processing circuit 508 being one or more of configured, employed, implemented, and/or programmed (in conjunction with the storage medium 510) to perform a particular process, function, step and/or routine according to various features described herein.

In some configurations, the apparatus 500 may be configured for constructing a neighbor list in a mobile station from a received existing system information message in the GERAN standard. In such configurations, the apparatus 500 may determine if a value in the system information message is equal to a predetermined EARFCN value for at least one cell identifier. The apparatus 500 may also set an extended EARFCN value to a further extended EARFCN value contained in the system information message if the value is equal to the predetermined EARFCN value. The apparatus 500 may also set the EARFCN value to the received value in the system information message if the value is less than the predetermined EARFCN value for the at least one cell identifier.

The control circuit 507 of the processing circuit 508 may include circuitry and other hardware components, which may perform various algorithms. Such circuitry, hardware components, and algorithms are some examples of structures corresponding to the means for determining if a value in the system information message is equal to a predetermined EARFCN value for at least one cell identifier. Such circuitry, hardware components, and algorithms are also some examples of structures corresponding to the means for determining whether an EARFCN value in an E-UTRAN neighbour cell structure is equal to a predetermined reserved value.

The settings circuit 509 of the processing circuit 508 may include circuitry and other hardware components, which may perform various algorithms. Such circuitry, hardware components, and algorithms are some examples of structures corresponding to the means for setting an extended EARFCN value to a further extended EARFCN value contained in the system information message if the value is equal to the predetermined EARFCN value. Such circuitry, hardware components, and algorithms are also some examples of structures corresponding to the means for setting the EARFCN value to the received value in the system information message if the value is less than the predetermined EARFCN value for the at least one cell identifier. Such circuitry, hardware components, and algorithms are also some examples of structures corresponding to the means for reconstructing an E-UTRAN neighbor cell list by replacing the predetermined reserved value with an extended EARFCN value included in an existing system information message if the EARFCN value in the E-UTRAN neighbor cell structure is equal to the predetermined reserved value. The extended EARFCN value may be greater than the predetermined reserved value. Such circuitry, hardware components, and algorithms are also some examples of structures corresponding to the means for decoding the E-UTRAN neighbour cell structure without using the extended EARFCN value included in the existing system information message if the EARFCN value is not equal to the predetermined reserved value.

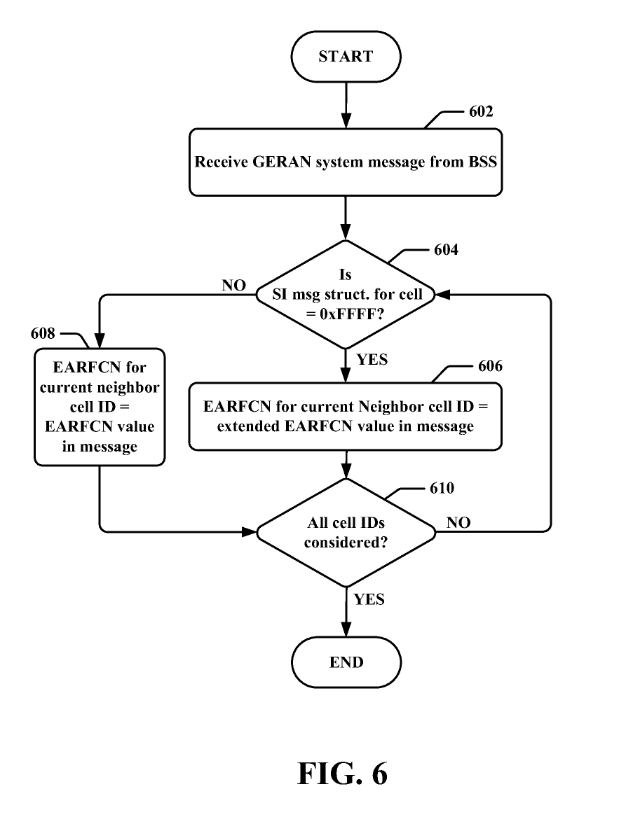

FIG. 6 is a flow diagram of a method for reconstructing a neighbour list implementable in an MS and/or UE based on received transmissions having the SI messages as provided above in connection with FIG. 3 and Table 1. As illustrated, an MS and/or UE may first receive GERAN system information messages from the BSS at block 602, wherein these messages are configured according to the methods described above. After the SI message (“SI msg”) is received, a determination is made whether the SI msg structure for a particular pertinent cell and/or the cell identifier (ID) is equal to the predetermined value 0xFFFF, as shown in decision block 604. If the value is equal to the predetermined value, the flow proceeds to block 606, where the SI msg is then further examined as the presence of this value points to another extended EARFCN value within the SI msg. The extended EARFCN value is then mapped to the current neighbour cell ID under consideration.

In the negative at decision block 604, the flow may proceed to a block 608 where the EARFCN for the current neighbour cell ID is set equal to the EARFCN value read from the SI message. In one aspect, the process of block 608 may be considered as an alternative example, as it is not absolutely necessary for a network to provide EARFCN values that are less than the value 0xFFFF, because the network could include only extended EARFCNs. In such case, decision block 604 may be modified to loop back on itself when the condition is answered in the negative.

After the processes of either block 606 or block 608 are executed (along with the reception of other parameters in the message in both block 606 and block 608), a determination may be made whether all neighbour cells have been considered for reconstruction of the neighbour list, as shown in decision block 610. If not, the flow proceeds back to block 604, until all information (e.g., EARFCNs) concerning all neighbouring cells present in the SI msg have been read and mapped to the neighbour list.

In light of the foregoing, it will be evident that the presently disclosed apparatus and methods provide an alternative approach to communicating extended EARFCN values wherein the extended EARFCN values are included in an extant information system information message (e.g., the SYSTEM INFORMATION Type 2quater message for GERAN). Although the proposed methods and apparatus extend the size of this broadcast message, it simplifies both the MS and BSS implementations. It is also noted that the increased power consumption due to increased overhead in the system information message, the power consumption will nonetheless be less than if a new SI message is used. This is because, in other proposed solutions, the mobile station would still have to read the existing SI message (e.g., the SYSTEM INFORMATION TYPE 2quater message) as well as additionally read the complete new system information message (e.g., the SYSTEM INFORMATION Type 23 message).

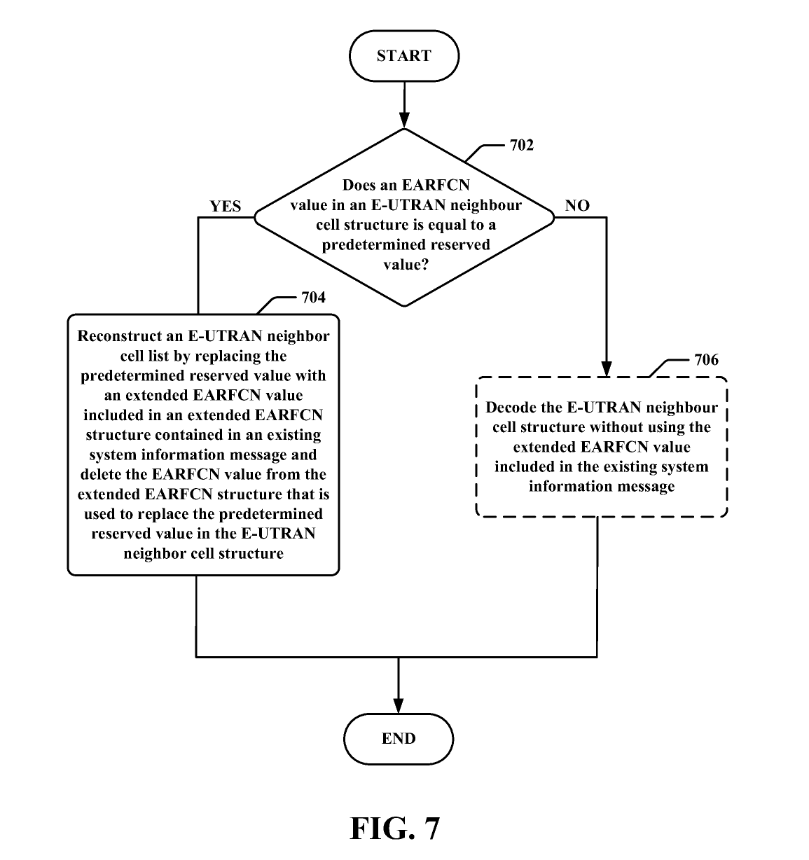

FIG. 7 is a flow diagram of a method for reconstructing a neighbour list implementable in an MS and/or UE. At block 702, the MS and/or UE may determine whether an EARFCN value in an E-UTRAN neighbour cell structure is equal to a predetermined reserved value. In some examples, the predetermined reserved value may include a value equal to 0xFFFF. If the E-UTRAN neighbour cell structure is equal to the predetermined value, at block 704, the MS and/or UE may reconstruct an E-UTRAN neighbour cell list by replacing the predetermined reserved value with an extended EARFCN value included in an existing system information message. The extended EARFCN value may have a value greater than the predetermined reserved value. For example, as shown above in Table 3, cell index 1 and cell index 2 have a transmitted neighbour cell structure that has a value equal to 0xFFFF, and the MS internal neighbour cell structure includes an extended EARFCN (e.g., EARFCN 2 and EARFCN 3, respectively), each of which has a value greater than 0xFFFF. As described in greater detail above, the existing system information message may be a SYSTEM INFORMATION TYPE 2quater message according to a GERAN standard.

However, if the E-UTRAN neighbour cell structure is not equal to the predetermined reserved value, at block 706, the MS and/or UE may decode the E-UTRAN neighbour cell structure without using the extended EARFCN value included in the existing system information message. For example, as shown above in Table 3, cell index 0 and cell index 3 have a transmitted neighbour cell structure that has a value less than the predetermined reserved value (e.g., less than 0xFFFF), and the MS internal neighbour cell structure includes a non-extended EARFCN (e.g., EARFCN 1 and EARFCN 4, respectively), each of which has a value less than 0xFFFF.

It is also noted that the various concepts presented throughout this disclosure may be implemented across a broad variety of telecommunication systems, network architectures, and communication standards. Certain aspects of the discussions are described herein in relation to GSM and in relation to 3GPP protocols and systems, and related terminology may be found in much of the foregoing description. However, those of ordinary skill in the art will recognize that one or more aspects of the present disclosure could be adapted to be employed and included in one or more other wireless communication protocols and systems.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow. The techniques described herein may be used for various communication systems, including communication systems that are based on an orthogonal multiplexing scheme.

The terms “memory” or “storage medium” may encompass any electronic component capable of storing electronic information. In particular, these terms may connote various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor. Also, the terms “instructions” and “code” may include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims. Finally, it is to be understood that the claims are not limited to the precise configuration and components illustrated above. Various modifications, changes and variations may be made in the arrangement, operation, and details of the systems, methods, and apparatus described herein without departing from the scope of the claims.

The above description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

1. A method of wireless communication, the method comprising:
determining whether an Evolved Universal Terrestrial Radio Access (E-UTRA) Absolute Radio Frequency Channel Number (EARFCN) value is greater than a predetermined reserved value for at least one neighbouring cell;
if the EARFCN value is greater than the predetermined reserved value, including the predetermined reserved value in an E-UTRA Network (E-UTRAN) neighbour cell structure and providing one or more extended EARFCNs used in the E-UTRAN in an extended EARFCN structure included in an existing system information message used in a Global System for Mobile Communications (GSM) random access network (RAN); and
communicating the existing system information message to at least one mobile station operable in the GSM RAN.

2. The method of claim 1, wherein the predetermined reserved value comprises a value equal to 0xFFFF.

3. The method of claim 2, wherein the GSM RAN comprises a GSM Enhanced Data rates for GSM Evolution (EDGE) RAN (GERAN).

4. The method of claim 3, wherein the existing system information message comprises a SYSTEM INFORMATION TYPE 2quater message according to a GERAN standard.

5. The method of claim 4, wherein the one or more extended EARFCNs are provided in the SYSTEM INFORMATION TYPE 2quater message to at least one non-GERAN network sharing mobile station.

6. The method of claim 1, further comprising:
if the EARFCN value is not greater than the predetermined reserved value, providing a non-extended EARFCN value in an existing system information message.

7. The method of claim 1, wherein the existing system information message is configured to allow the at least one mobile station operable in at least the GSM RAN to construct a neighbor list including one or more neighboring cells operable according to a Long Term Evolution (LTE) standard.

8. The method of claim 1, wherein the one or more extended EARFCNs are provided in the existing system information message for E-UTRAN Closed Subscriber Group (CSG) cells.

9. An apparatus for wireless communication, the apparatus comprising:
a communications interface;
a storage medium; and
at least one processor communicatively coupled to the communications interface and the storage medium, wherein the at least one processor and the storage medium are configured to:
determine whether an Evolved Universal Terrestrial Radio Access (E-UTRA) Absolute Radio Frequency Channel Number (EARFCN) value is greater than a predetermined reserved value for at least one neighbouring cell;
if the EARFCN value is greater than the predetermined reserved value, include the predetermined reserved value in an E-UTRA Network (E-UTRAN) neighbour cell structure and provide one or more extended EARFCNs used in the E-UTRAN in an extended EARFCN structure included in an existing system information message used in a Global System for Mobile Communications (GSM) random access network (RAN); and
communicate the existing system information message to at least one mobile station operable in the GSM RAN.

10. The apparatus of claim 9, wherein the predetermined reserved value comprises a value equal to 0xFFFF.

11. The apparatus of claim 10, wherein the GSM RAN comprises a GSM Enhanced Data rates for GSM Evolution (EDGE) RAN (GERAN).

12. The apparatus of claim 11, wherein the existing system information message comprises a SYSTEM INFORMATION TYPE 2quater message according to a GERAN standard.

13. The apparatus of claim 12, wherein the one or more extended EARFCNs are provided in the SYSTEM INFORMATION TYPE 2quater message to at least one non-GERAN network sharing mobile station.

14. The apparatus of claim 9 wherein the at least one processor and the storage medium are further configured to:
if the EARFCN value is not greater than the predetermined reserved value, provide a non-extended EARFCN value in an existing system information message.

15. The apparatus of claim 9, wherein the existing system information message is configured to allow the at least one mobile station operable in at least the GSM RAN to construct a neighbor list including one or more neighboring cells operable according to a Long Term Evolution (LTE) standard.

16. The apparatus of claim 9, wherein the one or more extended EARFCNs are provided in the existing system information message for E-UTRAN Closed Subscriber Group (CSG) cells.

17. A computer-readable medium comprising computer-executable instructions configured to:
determine whether an Evolved Universal Terrestrial Radio Access (E-UTRA) Absolute Radio Frequency Channel Number (EARFCN) value is greater than a predetermined reserved value for at least one neighbouring cell;
if the EARFCN value is greater than the predetermined reserved value, include the predetermined reserved value in an E-UTRA Network (E-UTRAN) neighbour cell structure and provide one or more extended EARFCNs used in the E-UTRAN in an extended EARFCN structure included in an existing system information message used in a Global System for Mobile Communications (GSM) random access network (RAN); and
communicate the existing system information message to at least one mobile station operable in the GSM RAN.

18. The computer-readable medium of claim 17, wherein the predetermined reserved value comprises a value equal to 0xFFFF.

19. The computer-readable medium of claim 18, wherein the GSM RAN comprises a GSM Enhanced Data rates for GSM Evolution (EDGE) RAN (GERAN).

20. The computer-readable medium of claim 19, wherein the existing system information message comprises a SYSTEM INFORMATION TYPE 2quater message according to a GERAN standard.

21. The computer-readable medium of claim 20, wherein the one or more extended EARFCNs are provided in the SYSTEM INFORMATION TYPE 2quater message to at least one non-GERAN network sharing mobile station.

22. The computer-readable medium of claim 17 wherein the computer-executable instructions is further configured to:
if the EARFCN value is not greater than the predetermined reserved value, provide a non-extended EARFCN value in an existing system information message.

23. The computer-readable medium of claim 17, wherein the existing system information message is configured to allow the at least one mobile station operable in at least the GSM RAN to construct a neighbor list including one or more neighboring cells operable according to a Long Term Evolution (LTE) standard.

24. The computer-readable medium of claim 17, wherein the one or more extended EARFCNs are provided in the existing system information message for E-UTRAN Closed Subscriber Group (CSG) cells.

25. A method of wireless communication, the method comprising:
determining whether an Evolved Universal Terrestrial Radio Access (E-UTRA) Absolute Radio Frequency Channel Number (EARFCN) value in an E-UTRA Network (E-UTRAN) neighbour cell structure is equal to a predetermined reserved value; and
if the EARFCN value in the E-UTRAN neighbor cell structure is equal to the predetermined reserved value, reconstructing an E-UTRAN neighbor cell list by replacing the predetermined reserved value with an extended EARFCN value included in an extended EARFCN structure contained in an existing system information message and deleting the EARFCN value from the extended EARFCN structure that is used to replace the predetermined reserved value in the E-UTRAN neighbor cell structure,
wherein the extended EARFCN value comprises a value greater than the predetermined reserved value.

26. The method of claim 25, wherein the predetermined reserved value comprises a value equal to 0xFFFF.

27. The method of claim 25, wherein the existing system information message is used in a Global System for Mobile Communications (GSM) Enhanced Data rates for GSM Evolution (EDGE) random access network (GERAN).

28. The method of claim 25, wherein the existing system information message comprises a SYSTEM INFORMATION TYPE 2quater message according to a GERAN standard.

29. The method of claim 25, further comprising:
if the EARFCN value is not equal to the predetermined reserved value, decoding the E-UTRAN neighbour cell structure without using the extended EARFCN value included in the existing system information message.

30. The method of claim 25, wherein the existing system information message is configured to allow the at least one mobile station operable in a Global System for Mobile Communications (GSM) random access network (RAN) to construct a neighbor list including one or more neighboring cells operable according to a Long Term Evolution (LTE) standard.
